(19) United States
(12) Patent Application Publication
(10) Pub. No.: US 2024/0219531 A1
(43) Pub. Date: Jul. 4, 2024

(54) DETECTOR MODULE AND RANGING DEVICE

(71) Applicant: Seer Microelectronics, Inc., Hsinchu County (TW)

(72) Inventor: Ming-Ching Kuo, Hsinchu County (TW)

(21) Appl. No.: 18/518,518

(22) Filed: Nov. 23, 2023

Related U.S. Application Data
(60) Provisional application No. 63/427,598, filed on Nov. 23, 2022.

(51) Int. Cl. G01S 7/4863; G01S 7/48; G01S 7/4865

(52) U.S. Cl. CPC G01S 7/4863; G01S 7/4808; G01S 7/4865

(57) ABSTRACT

A detector module and a ranging device are provided. The detector module includes a detector array including a plurality of pixel groups each of which has a plurality of ranging pixels. A first pixel group of the pixel groups includes a plurality of first ranging pixels each of which includes a first detection region. A second pixel group of the pixel groups includes a plurality of second ranging pixels each of which includes a second detection region. Area of the first detection region and area of the second detection region are different from each other. The ranging device provides higher accuracy due to difference area of the first detection region and the second detection region of the detector module.

### FIELD OF THE INVENTION

The present invention relates to a detector module and a ranging device, especially to a detector module and a ranging device based on single photon avalanche diode (SPAD).

### BACKGROUND OF THE INVENTION

Photodiodes are applied to lots of applications in various fields of daily life. Among them, Single photon avalanche diode (SPAD) may detect single photon even in low light scenarios due to its high sensitivity, and thus draws more attention in recent years.

When a pixel detector array of the SPAD receives returned photons with higher intensity, the pile-up effect may occur and worsen the measurement accuracy. Refer to FIG. 1, a schematic diagram showing pile-up of the SPAD histogram is provided. The dotted line in background represents laser pulse waveform of returned light. Due to dead time, the SPAD is unable to react in response to the next photon immediately after being triggered. The pile-up effect results in that a peak in the histogram is shifted to the left so that the detection time is less than the actual one, leading to ranging inaccuracy. While receiving strong returned light, a pixel sensor array with large effective area may have the histogram pile-up as shown in FIG. 1. Moreover, scenarios such as detection of highly reflective objects or near range object may aggravate the pile-up effect. Such that, while receiving photons with higher intensity, the pixel sensor array is unable to evaluate the reflectance of objects due to saturation.

Thus, there is a need to provide a ranging device with SPAD which solves the above problems and achieves higher accuracy.

### SUMMARY

An objective of the present application is to provide a detector module which may correct depth information to improve the accuracy of ranging devices by a detector array having a first detection region and a second detection region with different detection area from one another.

An objective of the present application is to provide a detector module which provides different measurement information for featuring different environmental characteristics by a detector array with a first detection region and a second detection region having different detection area from one another.

An objective of the present application is to provide a detector module which solves problems caused by strong returned light by a detector array with a first detection region and a second detection region having different detection area from one another.

An objective of the present application is to provide a detector module which measures time of flight by a plurality of ranging pixels having first ranging pixels and second ranging pixels in a detector array so as to improve resistance to sunlight and ambient light.

In order to achieve the above objects, a detector module according to the present invention includes a detector array including a plurality of pixel groups each of which has a plurality of ranging pixels. A first pixel group of the pixel groups includes a plurality of first ranging pixels each of which includes a first detection region. A second pixel group of the pixel groups includes a plurality of second ranging pixels each of which includes a second detection region. Area of the first detection region and area of the second detection region are different from each other. The detector module further includes a plurality of processing units and a plurality of digital processing units. The processing units are coupled to the detector array. The detector array receives the returned light to generate the detection signals. According to the detection signals, the processing units generate a plurality of ranging time of flight (ToF) signals. The digital processing units are selectively coupled to the processing units and generating a histogram information and perform statistical computing according to the ranging ToF signals.

In order to achieve the above objects, a ranging device according to the present invention includes a light emitting module, a detector module, a processor, and a digital processor. The light emitting module emits a detection light and the detector module receives the returned detection light to generate a detection signal. The detector module includes a detector array including a plurality of pixel groups each of which includes a plurality of ranging pixels. A first pixel group of the pixel groups includes a plurality of first ranging pixels, each of which includes a first detection region. A second pixel group of the pixel groups includes a plurality of second ranging pixels, each of which includes a second detection region. Area of the first detection region and area of the second detection region are different from each other. The processor which is coupled to the detector module generates a plurality of ranging time of flight (ToF) signals according to the detection signals. Then the digital processor which is coupled to the processor generates the histogram information and performs statistical computing according to the ranging ToF signals.

### BRIEF DESCRIPTION OF THE DRAWINGS

FIG. 1 is a schematic diagram showing the pile-up effect of histogram of a single photon avalanche diode;

FIG. 2 is a block diagram of a ranging device according to an embodiment of the present invention;

FIG. 3 is a block diagram of a ranging device according to an embodiment of the present invention;

FIG. 4 is a schematic diagram showing a detector array according to an embodiment of the present invention;

FIG. 5 is a schematic diagram showing histogram information generated by a detector array according to an embodiment of the present invention;

FIG. 6 is a schematic diagram showing coupling of the detector array to a processing unit of the embodiment in FIG. 4 according to the present invention;

FIG. 7 is a schematic diagram of the detector array shown in FIG. 4 according to another embodiment of the present invention;

FIG. 8 is a schematic diagram showing coupling of the detector array to a processing unit of the embodiment in FIG. 7 according to the present invention;

FIG. 9 is a schematic diagram of a detector array according to another embodiment of the present invention;

FIG. 10 is a schematic diagram showing coupling of the detector array to a processing unit of the embodiment in FIG. 9 according to the present invention;

FIG. 11 is a schematic diagram of a detector array according to another embodiment of the present invention;

FIG. 12 is a schematic diagram showing coupling of the detector array to a processing unit of the embodiment in FIG. 11 according to the present invention;

FIG. 13 is a schematic diagram of a detector array according to another embodiment of the present invention;

FIG. 14 is a schematic diagram showing coupling of the detector array to a processing unit of the embodiment in FIG. 13 according to the present invention;

FIG. 15 is a schematic diagram of a detector array according to another embodiment of the present invention;

FIG. 16 is a schematic diagram showing coupling of the detector array to a processing unit of the embodiment in FIG. 15 according to the present invention;

FIG. 17 is a schematic diagram of a detector array according to another embodiment of the present invention;

FIG. 18 is a schematic diagram showing coupling of the detector array to a processing unit of the embodiment in FIG. 17 according to the present invention;

FIG. 19 is a schematic diagram of a detector array according to another embodiment of the present invention; and

FIG. 20 is a schematic diagram showing coupling of the detector array to a processing unit of the embodiment in FIG. 19 according to the present invention.

### DETAILED DESCRIPTION

In order to learn features and functions of the present invention more clearly, please refer to the following embodiments and detailed description.

Certain terms are used in the description and claims to refer to particular elements. Those skilled in the art should understand that hardware manufacturers may use different terms to refer to the same component. The specification and claims do not use the difference in name as a way to distinguish components, but use the difference in function of components as a criterion for distinguishing. “Comprise/Include” mentioned throughout the specification and claims is an open term, so it should be interpreted as “including but not limited to”. In addition, the term “coupled” herein includes any direct and indirect means of connection. Therefore, if it is described that a first device is coupled to a second device, it means that the first device may be directly connected to the second device, or indirectly connected to the second device through other devices or connection means.

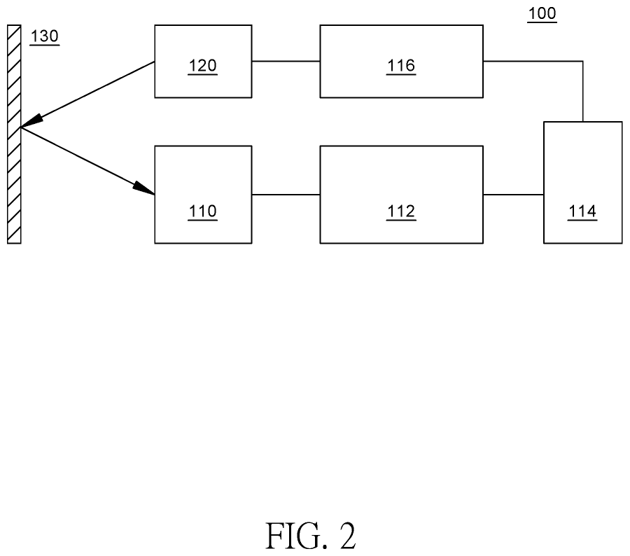

Refer to FIG. 2, a block diagram of an embodiment of a ranging device according to the present invention is provided. A ranging device 100 includes a light emitting module 120, a detector module 110, a timing control circuit 116, a processor 112, and a digital processor 114. The timing control circuit 116 outputs a trigger signal to the light emitting module 120 so that the light emitting module 120 emits a detection light to an object's surface 130 according to a preset period. The object's surface 130 reflects the detection light and then the detector module 110 receives the returned detection light to generate a detection signal. According to the detection signal, the processor 112 which is coupled to the detector module 110 generates a ranging time of flight (ToF) signal. The digital processor 114 which is coupled to the processor 112 generates a histogram information and performs statistical computing according to the ranging time of flight (ToF) signal.

The light emitting module 120 includes a light source which emits the detection light such as a laser. The detector module 110 includes a detector array which includes a plurality of pixel groups, each of which has a plurality of ranging pixels. As to the timing control circuit 116, it controls the light emitting module 120 to emit the detection light periodically. The processor 112 such as a detection processing circuit and time to digital converter (TDC) circuit may perform measurement of time of flight (ToF), convert ToF into a digital code, and output the digital code to the following digital processor 114. The digital processor 114 such as a digital signal processor (DSP) accumulates the digital codes to the histogram and performing statistical computing.

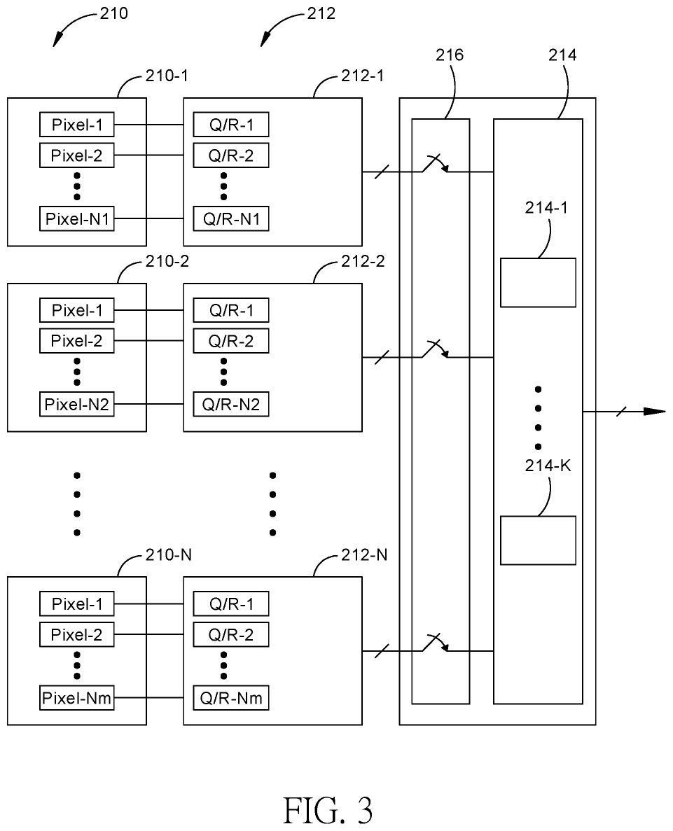

Refer to FIG. 3, a partial block diagram of an embodiment of a ranging device according to the present invention is provided. A detector array 210 includes a plurality of pixel groups 210-1 to 210-N, each of which has a plurality of ranging pixels. For example, a first pixel groups 210-1 includes a plurality of ranging pixels Pixel-1 to Pixel-N1. A processor 212 which is coupled to the detector array 210 includes a plurality of processing units 212-1 to 212-N, each of which includes a plurality of quench/recharge processing circuits. For example, a first processing unit 212-1 includes a plurality of quench/recharge processing circuits Q/R-1 to Q/R-N1. A digital processor 214 includes a plurality of digital processing units 214-1 to 214-K, each of which is selectively coupled to the processor 212 corresponding to a selector 216. For example, a first digital processing unit 214-1 maybe coupled to at least one or none of the processing units 212-1 to 212-N. The pixel groups 210-1 to 210-N are coupled to the corresponding digital processing units 214-1 to 214-K, the ranging pixels of the pixel groups 210-1 to 210-N are coupled to the corresponding quench/recharge processing circuits Q/R-1 to Q/R-N. For example, the ranging pixels Pixel-1 to Pixel-N1 of the first pixel groups 210-1 are respectively coupled to the quench/recharge processing circuits Q/R-1 to Q/R-N1. For instance, the ranging pixels Pixel-1 to Pixel-N1 are respectively coupled to corresponding detection front-end circuit (not shown in figure) for quench/recharge operation. The respective pixel groups may have the same or different number of the ranging pixels. For example, the first pixel group 210-1 includes N1 ranging pixels Pixel-1 to Pixel-N1 and the second pixel group 210-2 includes N2 ranging pixels Pixel-1 to Pixel-N2. N1 and N2 may be the same with or different from each other. The respective processing units may include the same or different number of the quench/recharge processing circuits. For example, the first processing unit 214-1 includes N1 quench/recharge processing circuits Q/R-1 to Q/R-N1, the second processing unit 214-2 includes N2 quench/recharge processing circuits Q/R-1 to Q/R-N2. N1 and N2 may be the same with or different from each other. The number of the digital processing units of the digital processor 214 may be the same with or different from the number of the pixel groups and the number of the processing units.

In this embodiment, photon detection signals generated by the ranging pixels are sent to the following processing unit. For example, the photon detection signals generated by the ranging pixels Pixel-1 to Pixel-N1 are sent to the following first processing unit 212-1, which executes correlation processing among multiple pixels. At least one set of time-to-digital converter (TDC) contained in the first processing unit 212-1 measures ranging time-of-flight and generates at least one set of time to digital code. Then at least one set of time to digital code generated by the respective pixel groups is selectively sent to the corresponding digital processing units 214-1 to 214-K through the corresponding selector 216. The selector 216 may be configured to selectively turn on or off the information generated by the respective pixel groups. The above selector 216 may be a multiplexer, a switching circuit, etc., but not limited. Each of the digital processing units 214-1 to 214-K may perform statistical computing such as histogram processing, but not limited. The statistical computing may be a histogram created by information of one of the pixel groups or information of a plurality of the pixel groups.

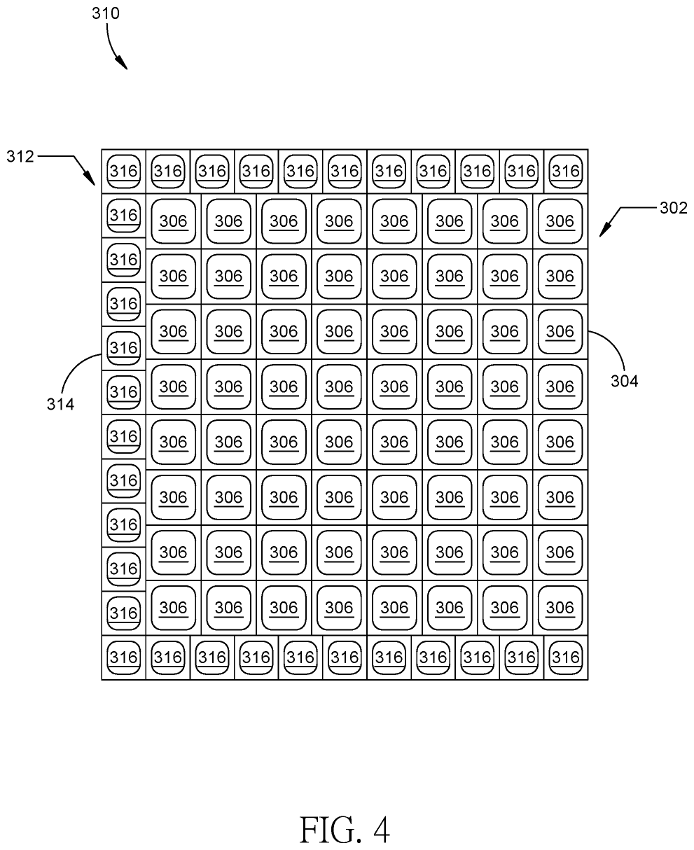

Refer to FIG. 4, a schematic diagram showing an embodiment of a detector array according to the present invention is provided. In this embodiment, a detector array 310 includes a first pixel group 302 and a second pixel group 312 respectively including a plurality of first ranging pixels 304 and a plurality of second ranging pixels 314. Each of the first ranging pixels 304 and each of the second ranging pixels 314 respectively include a first detection region 306 and a second detection region 316. The first ranging pixels 304 surrounded by the second ranging pixels 314 to form the detector array 310. The surrounding way is not limited as shown in the figure. For example, four sides of the first ranging pixels 304 are all surrounded by the second ranging pixels 314 or only two of the four sides of the first ranging pixels 304 are surrounded by the second ranging pixels 314.

In this embodiment, area of the first ranging pixels 304 is larger than area of the second ranging pixels 314, or area of a plurality of the first detection regions 306 is larger than area of a plurality of the second detection regions 316. The detection region represents actually effective area of the ranging pixel for receiving photons, the detection region is able to be changed by other methods. For example, ranging pixels with reduced detection efficiency may be implemented by small size/small detection region or by large size/large detection region which is covered with a shielding layer such as a metal shielding layer. The area of the detection region may be changed with the shielding layer to adjust the receiving amount of incident light. The ranging pixels with different detection area from one another may be achieved by arranging the shielding layer over the different ranging pixels with the same area of active regions. When the ranging pixels are not covered with the shielding layer, the detection regions of the ranging pixels are equal to the active regions of the ranging pixels. Thereby problems caused by strong reflected light in different scenarios such as ranging with highly reflective object or in a short distance may be improved by the first ranging pixels 304 and the second ranging pixels 314 respectively having the first detection regions 306 and the second detection regions 316 with different detection area from each other.

The detector array 310 includes a combination of the first ranging pixels 304 and the second ranging pixels 314 with different sizes and detection area. Using pixels with different detection areas to simultaneously sense the depth of the same object may get a more accurate measurement distance while ensuring a high sampling rate. Some specific measurement environments such as ranging with highly reflective object or in a short distance may have a high inaccuracy due to the pile-up effect. Under these scenarios, ranging pixels with different detection area may respond to different characteristics of returned light. In general, ranging pixels with large detection area may suffer from more severe pile-up effect, but ranging pixels with small detection area may be immune from the pile-up effect. Ranging pixels with different detection area may produce different measurement information, characterizing different scenarios. These characteristics such as the width of the histogram peak may be applied for further calibration to improve the accuracy.

In another embodiment, a plurality of the second ranging pixels 314 are surrounded by a plurality of the first ranging pixels 304 to form a detector array 310. For example, four sides of the second ranging pixels 314 are surrounded by the first ranging pixels 304 or two of the four sides of the second ranging pixels 314 are surrounded by the first ranging pixels 304. Thereby problems caused by strong reflected light in different scenarios such as ranging with highly reflective object or in a short distance may be improved by the first ranging pixels 304 and the second ranging pixels 314 respectively having the first detection regions 306 and the second detection regions 316 with different detection area from each other.

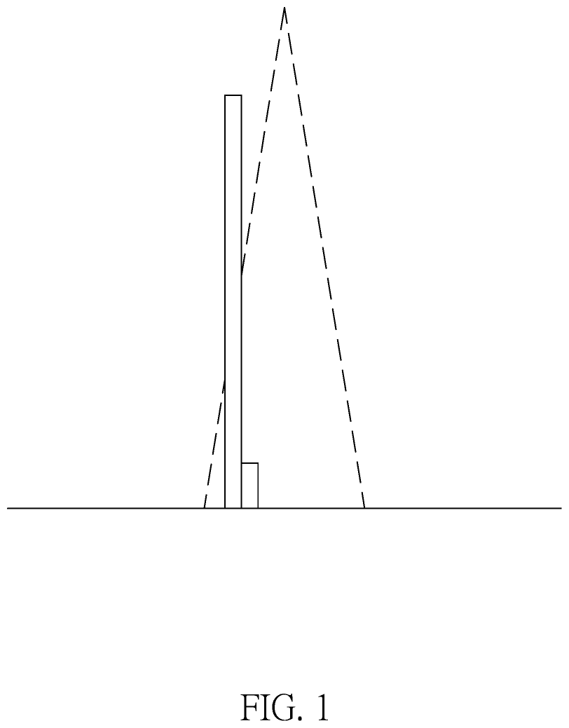

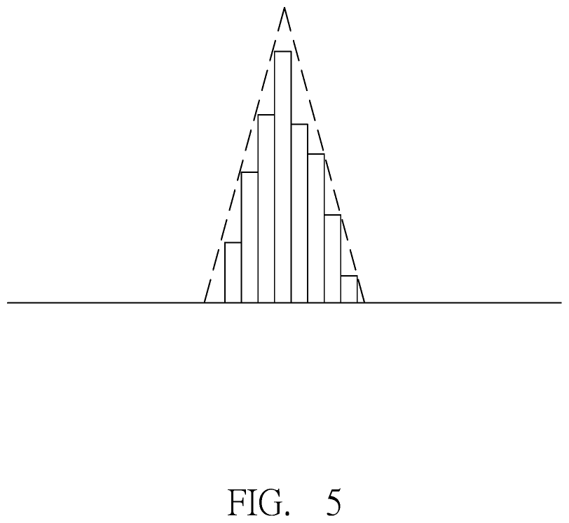

Refer to FIG. 5, a schematic diagram showing histogram information generated by a detector array of an embodiment according to the present invention is provided. Refer to FIG. 1 and FIG. 5, histogram shown in FIG. 5 is under a low returned light environment and exhibits a Gaussian distribution, where the waveform and the peak of the laser pulse may be reflected faithfully. Compared with the histogram information of conventional SPAD having pile-up, the detector array according to the present invention, comprising ranging pixels with different detection area may provide different measurement information. For example, even under environment with strong returned light, the second ranging pixels having small detection area may be immune from the pile-up effect and characterize the histogram information shown in FIG. 5. The non-distorted histogram information may be applied for further calibration to improve the accuracy.

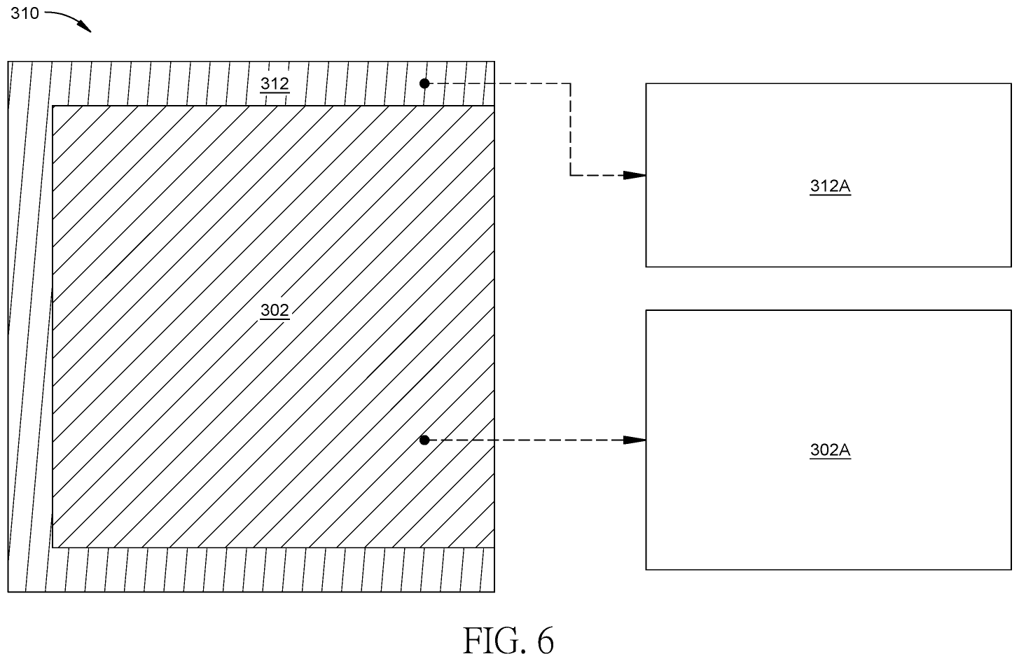

Refer to FIG. 6, a schematic diagram showing coupling of the detector array to processing units of the embodiment in FIG. 4 according to the present invention is provided. The first pixel group 302 and the second pixel group 312 of the detector array 310 are correspondingly coupled to different processing units. As shown in figure, the first pixel group 302 and the second pixel group 312 are respectively coupled to a processing unit 302A and a processing unit 312A. The processing units 302A, 312A include a detection processing circuit and a time measurement unit and sued for measuring time-of-flight, converting time information measured into digital signals, and outputting the digital signals to the following processing circuit for further signal processing such as statistical computing of histograms.

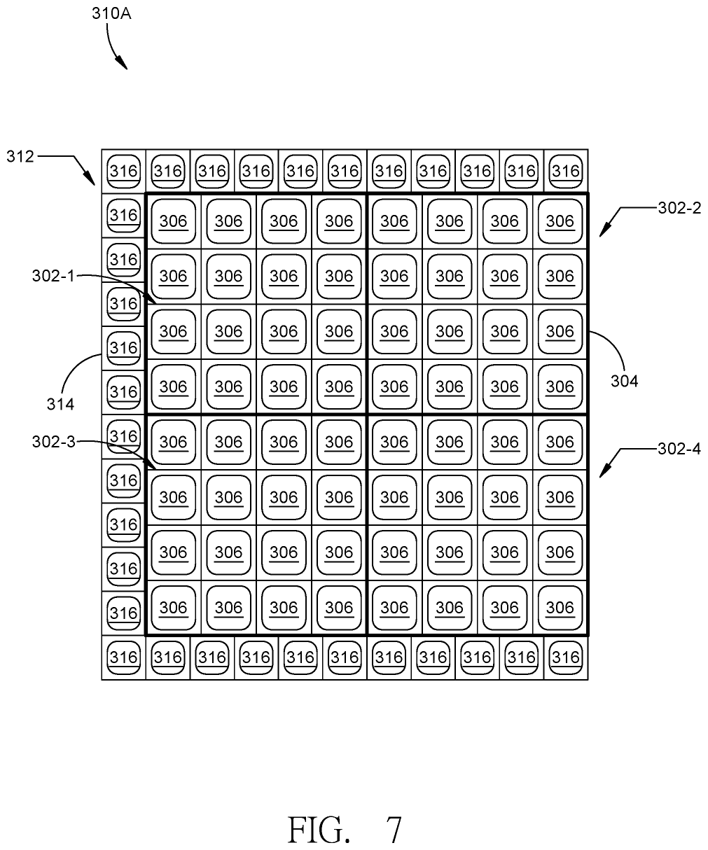

Refer to FIG. 7, a schematic diagram showing another embodiment of the detector array shown in FIG. 4 according to the present invention is provided. A detector array 310A includes a first pixel group 302-1, a second pixel group 302-2, a third pixel group 302-3, a fourth pixel group 302-4, and a fifth pixel group 312. Each of the first pixel group 302-1, the second pixel group 302-2, the third pixel group 302-3, and the fourth pixel group 302-4 includes a plurality of first ranging pixels 304, the fifth pixel group 312 includes a plurality of second ranging pixels 314. In this embodiment, each of the first pixel group 302-1, the second pixel group 302-2, the third pixel group 302-3, and the fourth pixel group 302-4 includes the same number of first ranging pixels 304. The respective first ranging pixels 304 of the first pixel group 302-1, the second pixel group 302-2, the third pixel group 302-3, and the fourth pixel group 302-4 are used for measurement of time-of-flight. When characteristics of the returned light obtained by the time-of-flight measured by the ranging pixels of a part of the pixel groups match conditions of a strong returned light (such as pile-up characteristic of the histogram in FIG. 1 or a value of intensity of the returned light meets a threshold value), it is determined that the part of the pixel groups is affected by the strong returned light. At the moment, pixel groups without being affected may be selected to perform detection and increase resistance to ambient light such as sunlight. The identification of characteristics of strong returned light and its calibration may be executed by the digital processor 114 or a back-end controller.

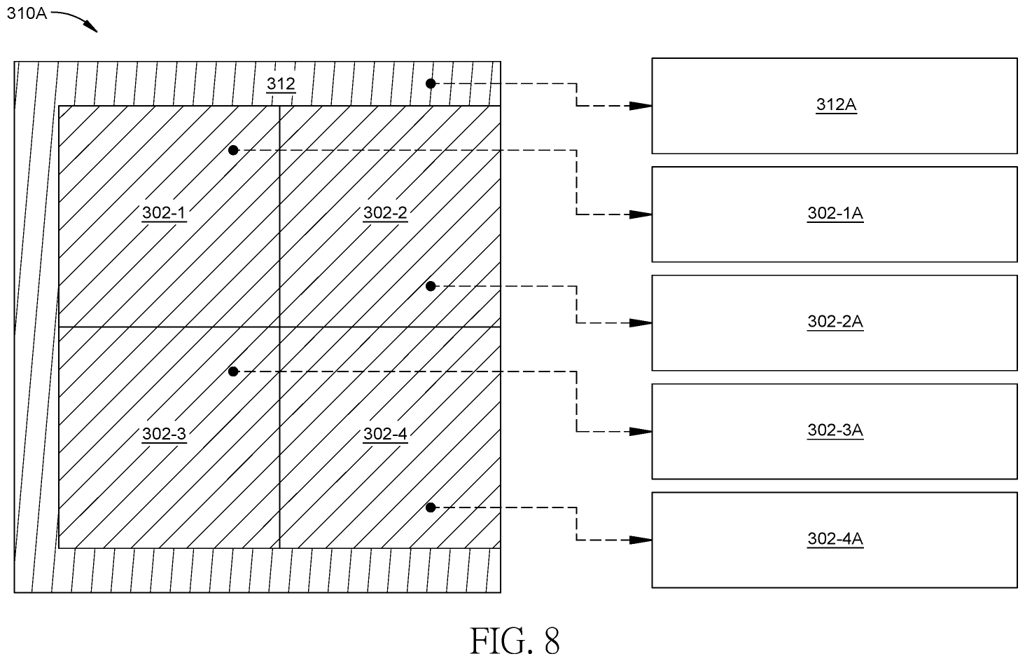

Refer to FIG. 8, a schematic diagram showing coupling of the detector array to processing units of the embodiment in FIG. 7 according to the present invention is provided. The first pixel group 302-1, the second pixel group 302-2, the third pixel group 302-3, the fourth pixel group 302-4, and the fifth pixel group 312 of the detector array 310A are correspondingly coupled to different processing units. As shown in figure, first pixel group 302-1, the second pixel group 302-2, the third pixel group 302-3, the fourth pixel group 302-4, and the fifth pixel group 312 are respectively coupled to a processing unit 302-1A, a processing unit 302-2A, a processing unit 302-3A, a processing unit 302-4A, and a processing unit 312A. Each of the processing units 302-1A, 302-2A, 302-3A, 302-4A, and 312A includes a detection processing circuit and a time measurement unit and used to measure time-of-flight, convert time information measured into digital signals, and output the digital signals to the following processing circuit for further signal processing such as statistical computing of histograms.

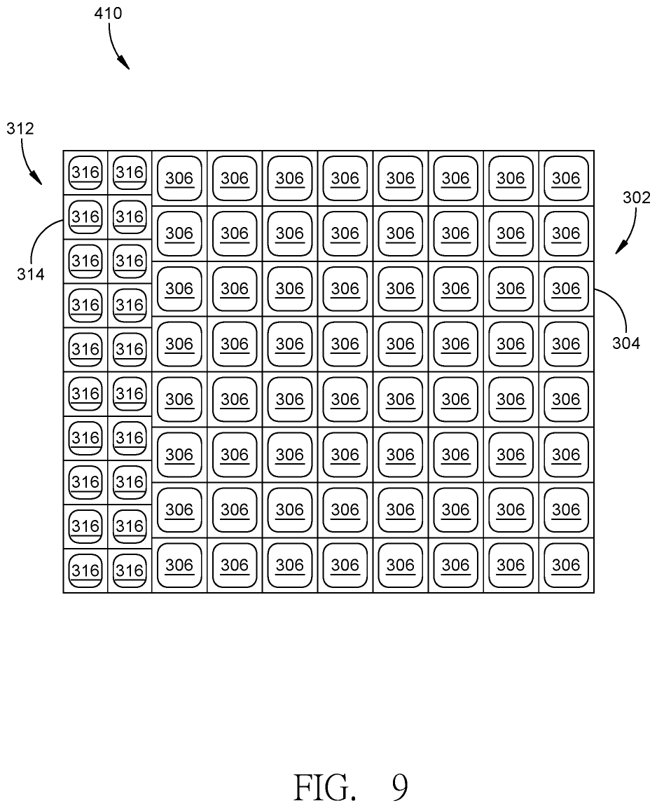

Refer to FIG. 9, a schematic diagram showing another embodiment of a detector array according to the present invention is provided. A detector array 410 includes a first pixel group 302 and a second pixel group 312 respectively including a plurality of first ranging pixels 304 and a plurality of second ranging pixels 314. Each of the first ranging pixels 304 and each of the second ranging pixels 314 respectively include a first detection region 306 and a second detection region 316. The second ranging pixels 314 are arranged at one side of the first ranging pixels 304 to form the detector array 410 and the arrangement is not limited as shown in the figure. For example, the second ranging pixels 314 may be disposed on one of the four sides of the first ranging pixels 304. Thereby problems caused by strong reflected light in different scenarios such as ranging with highly reflective object or in a short distance may be improved by the first ranging pixels 304 and the second ranging pixels 314 respectively having the first detection regions 306 and the second detection regions 316 with different detection area from each other.

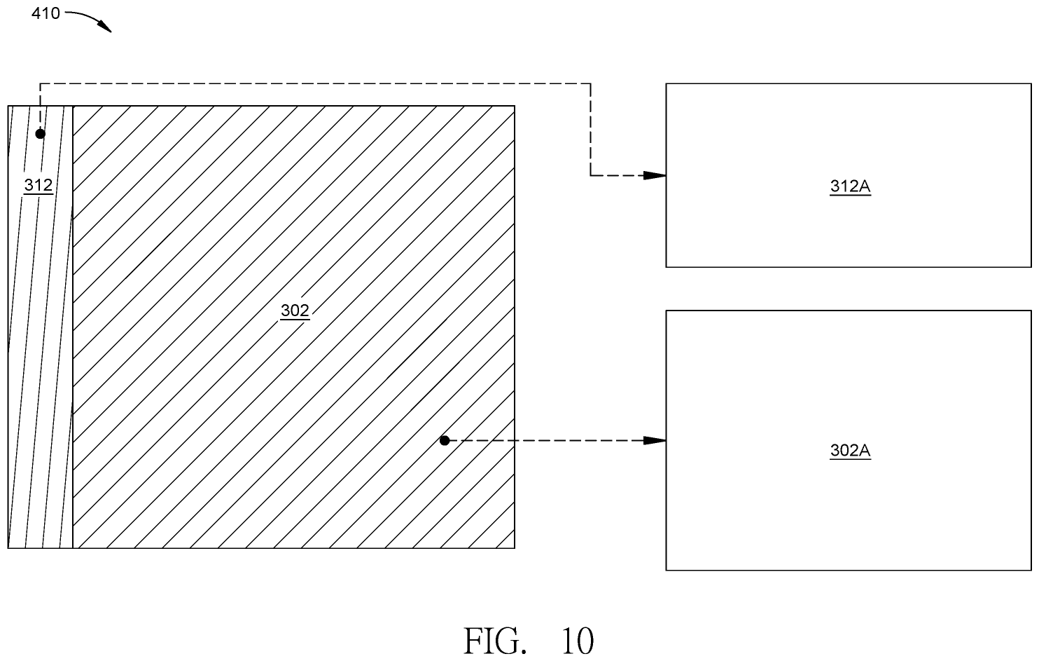

Refer to FIG. 10, a schematic diagram showing coupling of the detector array to processing units of the embodiment in FIG. 9 according to the present invention is provided. The first pixel group 302 and the second pixel group 312 of the detector array 410 are correspondingly coupled to different processing units. As shown in figure, the first pixel group 302 and the second pixel group 312 are respectively coupled to a processing unit 302A and a processing unit 312A. Each of the processing units 302A, 312A includes a detection processing circuit and a time measurement unit to measure time-of-flight, convert time information measured into digital signals, and output the digital signals to the following processing circuit for further processing such as statistical computing of histograms.

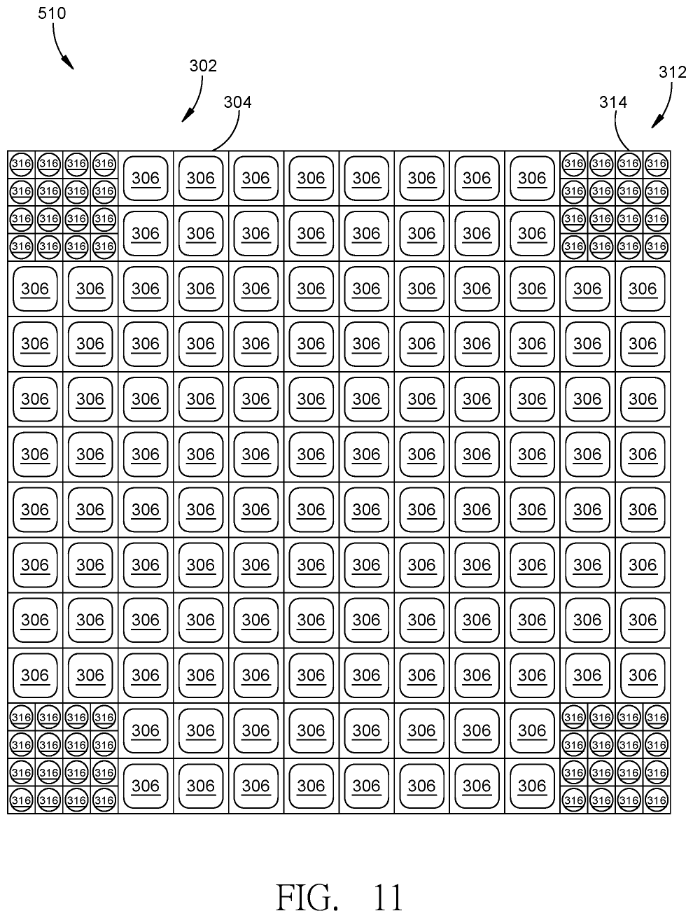

Refer to FIG. 11, a schematic diagram showing another embodiment of a detector array according to the present invention is provided. A detector array 510 includes a first pixel group 302 and a second pixel group 312 respectively including a plurality of first ranging pixels 304 and a plurality of second ranging pixels 314. Each of the first ranging pixels 304 and each of the second ranging pixels 314 respectively include a first detection region 306 and a second detection region 316. The second ranging pixels 314 are disposed on at least one of corners of the detector array 510 and surrounded by the first ranging pixels 304 to form the detector array 510 and the arrangement is not limited as shown in the figure. For example, the second ranging pixels 314 may be arranged at one, two, or three of four corners of the detector array 510 and the number of the second ranging pixels 314 mounted to the respective corners may be different. Thereby problems caused by strong reflected light in different scenarios such as ranging with highly reflective object or in a short distance may be improved by the first ranging pixels 304 and the second ranging pixels 314 respectively having the first detection regions 306 and the second detection regions 316 with different detection area from each other.

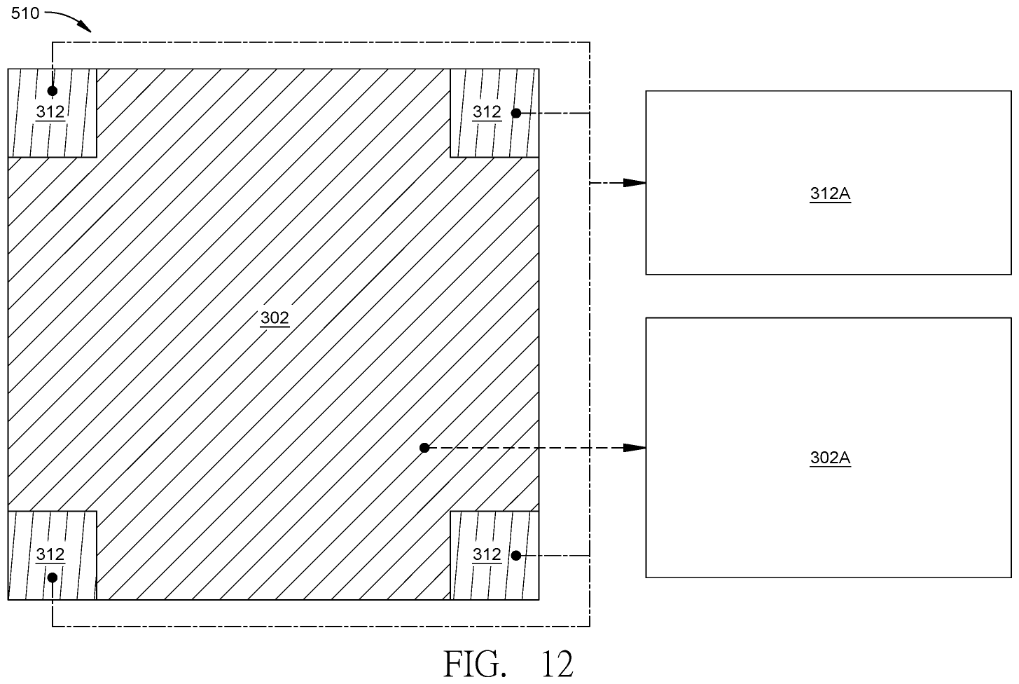

Refer to FIG. 12, a schematic diagram showing coupling of the detector array to processing units of the embodiment in FIG. 11 according to the present invention is provided. The first pixel group 302 and the second pixel group 312 of the detector array 510 are correspondingly coupled to different processing units. As shown in figure, the first pixel group 302 and the second pixel group 312 are respectively coupled to a processing unit 302A and a processing unit 312A. Each of the processing units 302A, 312A includes a detection processing circuit and a time measurement unit to measure time-of-flight, convert time information measured into digital signals, and output the digital signals to the following processing circuit for further processing such as statistical computing of histograms.

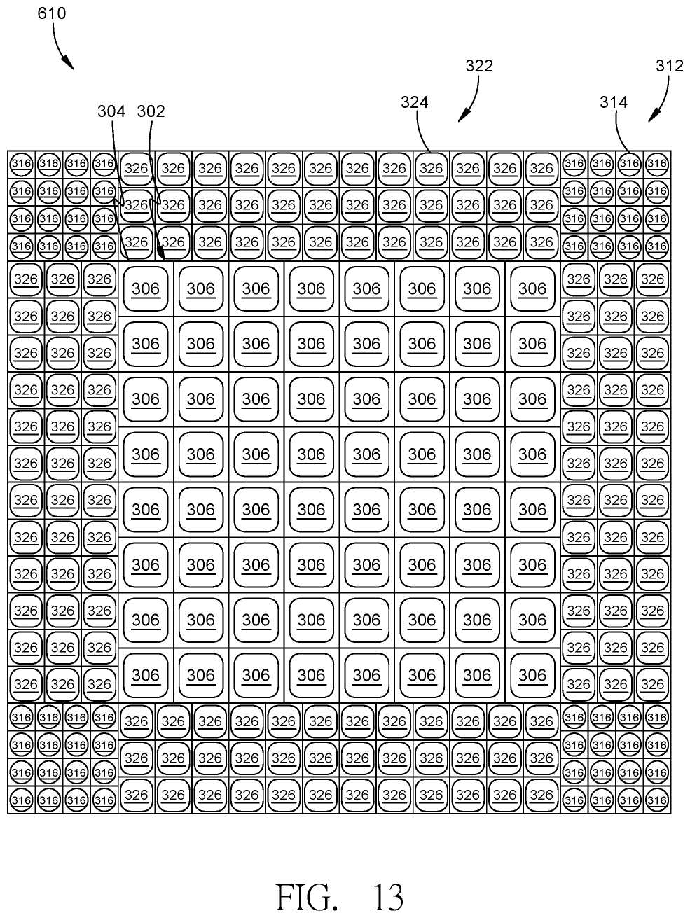

Refer to FIG. 13, a schematic diagram showing another embodiment of a detector array according to the present invention is provided. A detector array 610 includes a first pixel group 302, a second pixel group 312, a third pixel group 322 respectively including a plurality of first ranging pixels 304, a plurality of second ranging pixels 314, and a plurality of third ranging pixels 324. Each of the first ranging pixels 304, each of the second ranging pixels 314 and each of the third ranging pixels 324 respectively include a first detection region 306, a second detection region 316, and a third detection region 326. The first ranging pixels 304 are surrounded by the second ranging pixels 314 and the third ranging pixels 324 to form the detector array 610 and the arrangement is not limited as shown in the figure. For example, the second ranging pixels 314 may be disposed on sides of the first ranging pixels 304, the third ranging pixels 324 may be arranged at corners.

In this embodiment, area of the first ranging pixels 304 is larger than area of the third ranging pixels 324, area of the third ranging pixels 324 is larger than area of the second ranging pixels 314. Or area of the first detection regions 306 is larger than area of the third detection regions 326, area of the third detection regions 326 is larger than area of the second detection regions 316. Thereby problems caused by strong reflected light in different scenarios such as ranging with highly reflective object or in a short distance may be improved by the first ranging pixels 304, the second ranging pixels 314, and the third ranging pixels 324 respectively having the first detection regions 306, the second detection regions 316, and the third detection regions 326 with different detection area from one another.

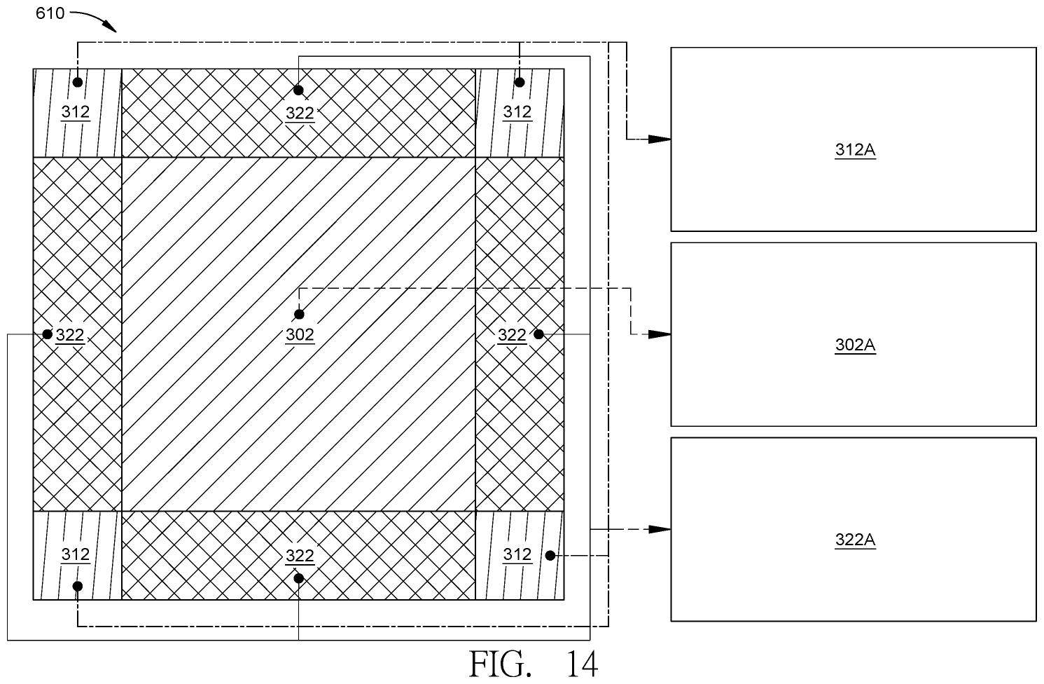

Refer to FIG. 14, a schematic diagram showing coupling of the detector array to processing units of the embodiment in FIG. 13 according to the present invention is provided. The first pixel group 302, the second pixel group 312, and the third pixel group 322 of the detector array 610 are correspondingly coupled to different processing units. As shown in figure, the first pixel group 302, the second pixel group 312, and the third pixel group 322 are respectively coupled to a processing unit 302A, a processing unit 312A, and a processing unit 322A. Each of the processing units 302A, 312A, 322A includes a detection processing circuit and a time measurement unit and used to measure time-of-flight, convert time information measured into digital signals, and output the digital signals to the following processing circuit for further processing such as statistical computing of histograms.

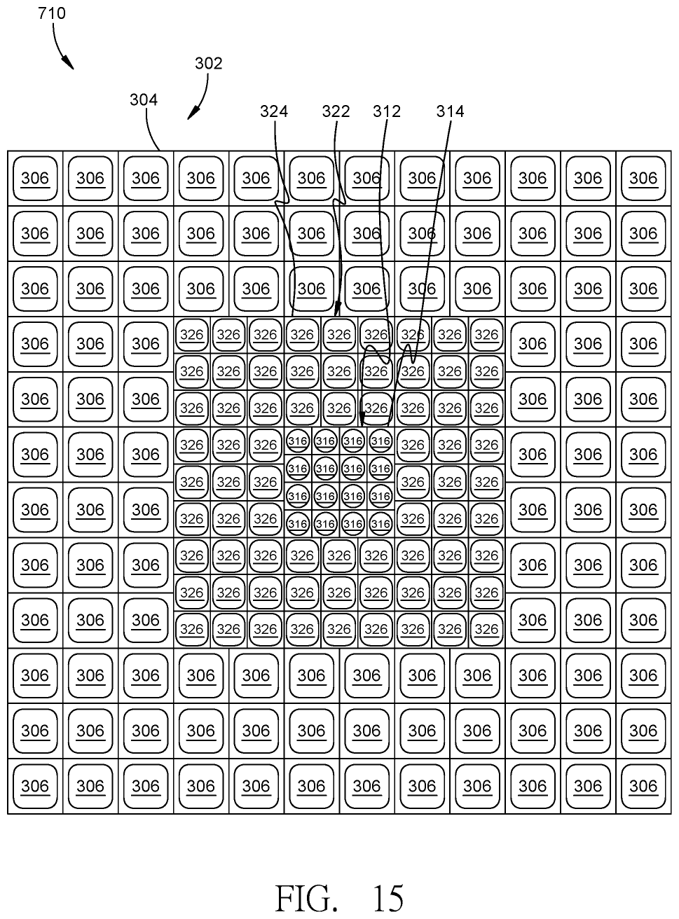

Refer to FIG. 15, a schematic diagram showing another embodiment of a detector array according to the present invention is provided. A detector array 710 includes a first pixel group 302, a second pixel group 312, and a third pixel group 322 respectively including a plurality of first ranging pixels 304, a plurality of second ranging pixels 314, and a plurality of third ranging pixels 324. Each of the first ranging pixels 304, each of the second ranging pixels 314 and each of the third ranging pixels 324 respectively includes a first detection region 306, a second detection region 316, and a third detection region 326. The third ranging pixels 324 are surrounded by the first ranging pixels 304 and the second ranging pixels 314 are surrounded by the third ranging pixels 324 to form the detector array 710 and the arrangement is not limited as shown in the figure. Thereby problems caused by strong reflected light in different scenarios such as ranging with highly reflective object or in a short distance may be improved by the first ranging pixels 304, the second ranging pixels 314, and the third ranging pixels 324 respectively having the first detection regions 306, second detection regions 316, and the third detection regions 326 with different detection area from one another.

In another embodiment, the third ranging pixels 324 are surrounded by the second ranging pixels 314 and the first ranging pixels 304 are surrounded by the third ranging pixels 324 to form the detector array 710. Thereby problems caused by strong reflected light in different scenarios such as ranging with highly reflective object or in a short distance may be improved by the first ranging pixels 304, the second ranging pixels 314, and the third ranging pixels 324 respectively having the first detection regions 306, second detection regions 316, and the third detection regions 326 with different detection area from one another.

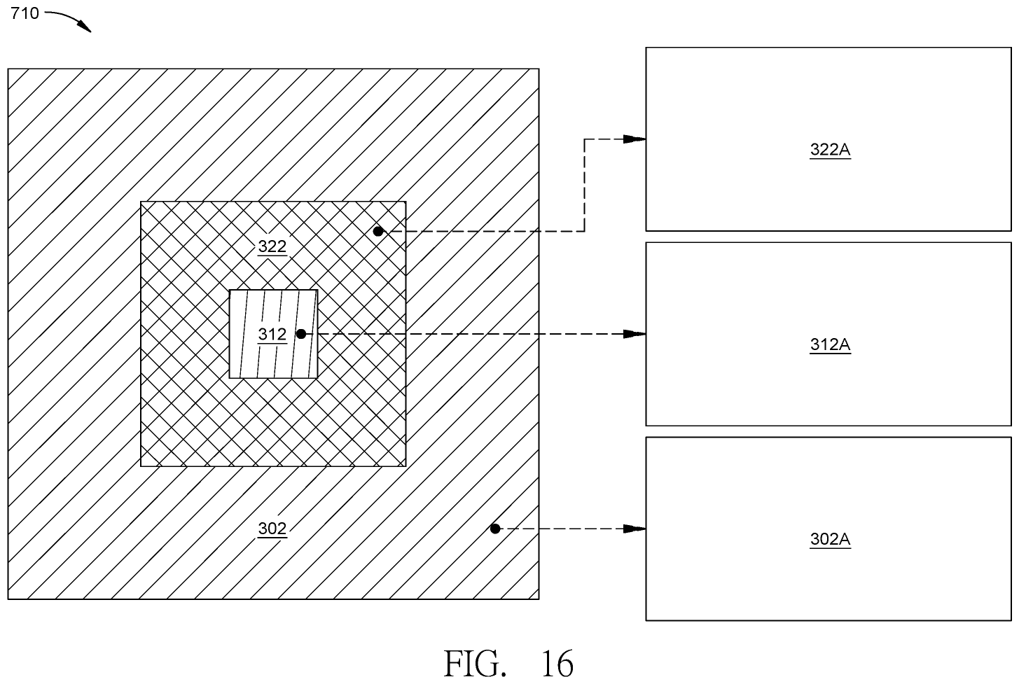

Refer to FIG. 16, a schematic diagram showing coupling of the detector array to processing units of the embodiment in FIG. 15 according to the present invention is provided. The first pixel group 302, the second pixel group 312, and the third pixel group 322 of the detector array 710 are correspondingly coupled to different processing units. As shown in figure, the first pixel group 302, the second pixel group 312, and the third pixel group 322 are respectively coupled to a processing unit 302A, a processing unit 312A, and a processing unit 322A. Each of the processing units 302A, 312A, 322A includes a detection processing circuit and a time measurement unit to measure time-of-flight, convert time information measured into digital signals, and output the digital signals to the following processing circuit for further processing such as statistical computing of histograms.

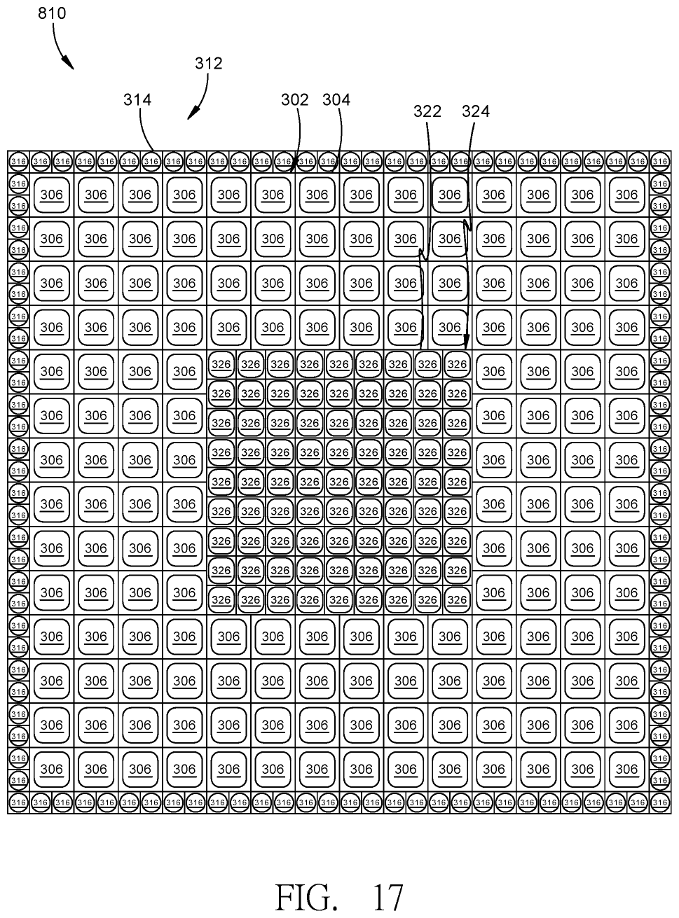

Refer to FIG. 17, a schematic diagram showing another embodiment of a detector array according to the present invention is provided. A detector array 810 includes a first pixel group 302, a second pixel group 312, a third pixel group 322 respectively including a plurality of first ranging pixels 304, a plurality of second ranging pixels 314, and a plurality of third ranging pixels 324. Each of the first ranging pixels 304, each of the second ranging pixels 314 and each of the third ranging pixels 324 respectively includes a first detection region 306, a second detection region 316, and a third detection region 326. The third ranging pixels 324 are surrounded by the first ranging pixels 304, the first ranging pixels 304 are surrounded by the second ranging pixels 314 to form the detector array 810. Thereby problems caused by strong reflected light in different scenarios such as ranging with highly reflective object or in a short distance may be improved by the first ranging pixels 304, the second ranging pixels 314, and the third ranging pixels 324 respectively having the first detection regions 306, second detection regions 316, and the third detection regions 326 with different detection area from one another.

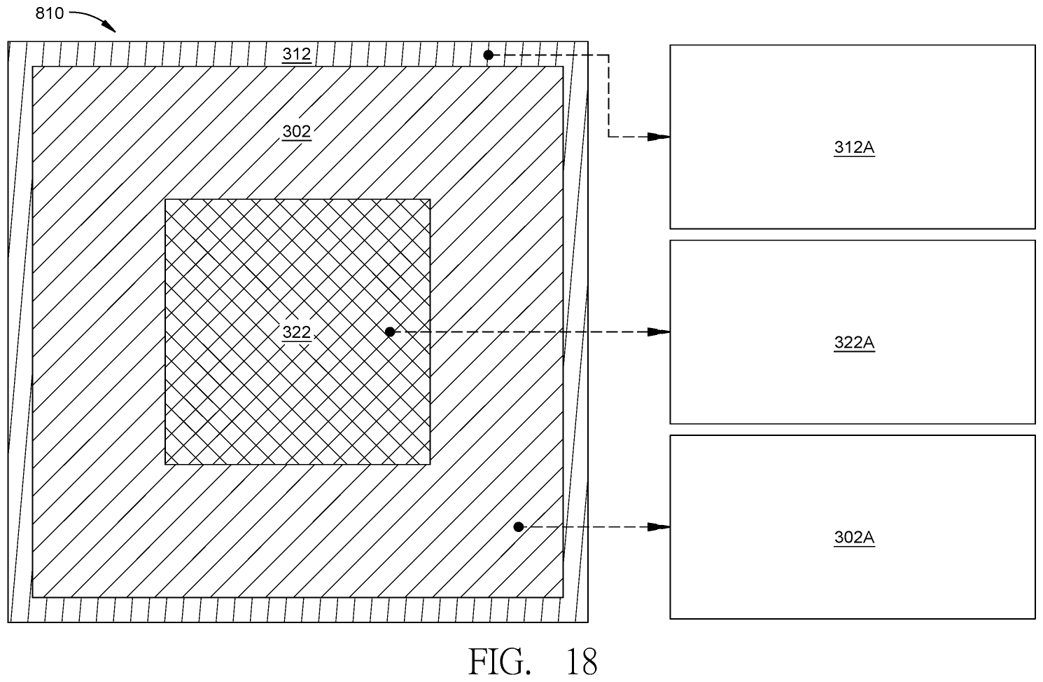

Refer to FIG. 18, a schematic diagram showing coupling of the detector array to a processing unit of the embodiment in FIG. 17 according to the present invention is provided. The first pixel group 302, the second pixel group 312, and the third pixel group 322 of the detector array 810 are correspondingly coupled to different processing units. As shown in figure, the first pixel group 302, the second pixel group 312, and the third pixel group 322 are respectively coupled to a processing unit 302A, a processing unit 312A, and a processing unit 322A. Each of the processing units 302A, 312A, 322A includes a detection processing circuit and a time measurement unit to measure time-of-flight, convert time information measured into digital signals, and output the digital signals to the following processing circuit for further processing such as statistical computing of histograms.

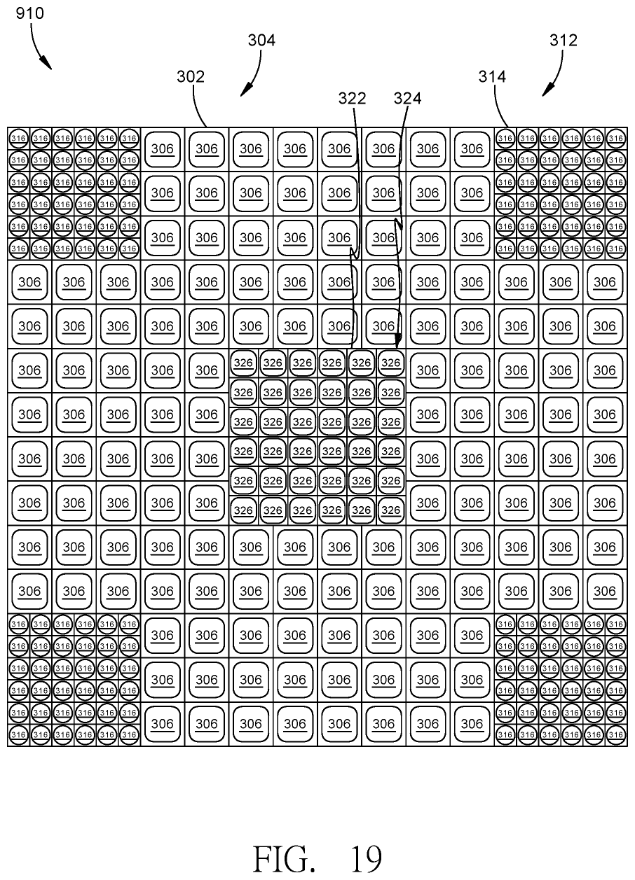

Refer to FIG. 19, a schematic diagram showing another embodiment of a detector array according to the present invention is provided. A detector array 910 includes a first pixel group 302, a second pixel group 312, a third pixel group 322 respectively including a plurality of first ranging pixels 304, a plurality of second ranging pixels 314, and a plurality of third ranging pixels 324. Each of the first ranging pixels 304, each of the second ranging pixels 314 and each of the third ranging pixels 324 respectively includes a first detection region 306, a second detection region 316, and a third detection region 326. The second ranging pixels 314 are disposed on at least one corner of the detector array 910 and the third ranging pixels 324 is arranged at a center of the detector array 910, the second ranging pixels 314 and the third ranging pixels 324 are surrounded by the first ranging pixels 304 to form the detector array 910 and the arrangement is not limited as shown in the figure. Thereby problems caused by strong reflected light in different scenarios such as ranging with highly reflective object or in a short distance may be improved by the first ranging pixels 304, the second ranging pixels 314, and the third ranging pixels 324 respectively having the first detection regions 306, the second detection regions 316, and the third detection regions 326 with different detection area from one another.

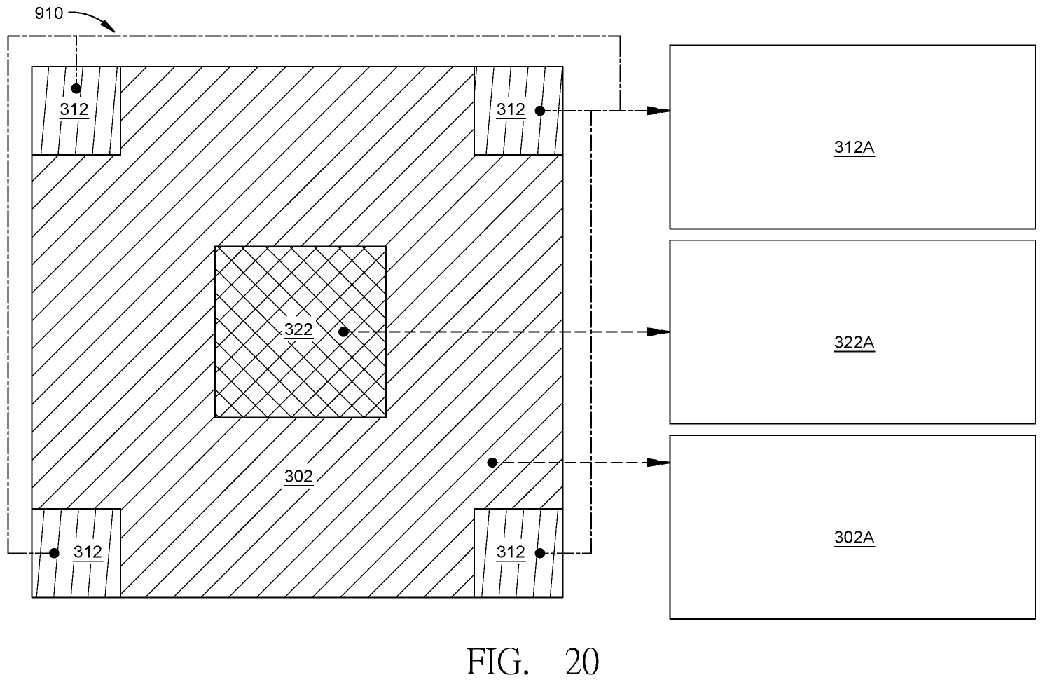

Refer to FIG. 20, a schematic diagram showing coupling of the detector array to a processing unit of the embodiment in FIG. 19 according to the present invention is provided. The first pixel group 302, the second pixel group 312, and the third pixel group 322 of the detector array 910 are correspondingly coupled to different processing units. As shown in figure, the first pixel group 302, the second pixel group 312, and the third pixel group 322 are respectively coupled to a processing unit 302A, a processing unit 312A, and a processing unit 322A. Each of the processing units 302A, 312A, 322A includes a detection processing circuit and a time measurement unit to measure time-of-flight, convert time information measured into digital signals, and output the digital signals to the following processing circuit for further processing such as statistical computing of histograms.

The present invention meets requirements for novelty, utility, and non-obviousness.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A detector module of ranging devices comprising:
a detector array including:
a plurality of pixel groups, each of the pixel groups including a plurality of ranging pixels, a first pixel group of the pixel groups including a plurality of first ranging pixels, each of the first ranging pixels including a first detection region, a second pixel group of the pixel groups including a plurality of second ranging pixels, each of the second ranging pixels including a second detection region, wherein area of the first detection region and area of the second detection region are different from each other.

2. The detector module as claimed in claim 1, wherein area of the first ranging pixels is larger than area of the second ranging pixels.

3. The detector module as claimed in claim 1, wherein area of the first detection regions of the first ranging pixels is larger than area of the second detection regions of the second ranging pixels.

4. The detector module as claimed in claim 1, wherein the first ranging pixels are surrounded by the second ranging pixels to form the detector array.

5. The detector module as claimed in claim 1, wherein the second ranging pixels are disposed on one side of the first ranging pixels to form the detector array.

6. The detector module as claimed in claim 1, wherein the second ranging pixels are disposed on at least one corner of the detector array and surrounded by the first ranging pixels to form the detector array.

7. The detector module as claimed in claim 1, wherein a third pixel group of the pixel groups includes a plurality of third ranging pixels, area of the first ranging pixels is larger than area of the third ranging pixels, the area of the third ranging pixels is larger than area of the second ranging pixels.

8. The detector module as claimed in claim 7, wherein each of the third ranging pixels includes a third detection region, area of the first detection regions of the first ranging pixels is larger than area of the third detection regions of the third ranging pixels, area of the third detection regions of the third ranging pixels is larger than area of the second detection regions of the second ranging pixels.

9. The detector module as claimed in claim 7, wherein the first ranging pixels are surrounded by the second ranging pixels and the third ranging pixels to form the detector array.

10. The detector module as claimed in claim 7, wherein the third ranging pixels are surrounded by the first ranging pixels and the second ranging pixels are surrounded by the third ranging pixels to form the detector array.

11. The detector module as claimed in claim 7, wherein the third ranging pixels are surrounded by the first ranging pixels and the first ranging pixels are surrounded by the second ranging pixels to form the detector array.

12. The detector module as claimed in claim 7, wherein the second ranging pixels are disposed on at least one corner of the detector array and the third ranging pixels are arranged at a center of the detector array, the second ranging pixels and the third ranging pixels are surrounded by the first ranging pixels to form the detector array.

13. The detector module as claimed in claim 1, further including:
a plurality of processing units, respectively coupled to the pixel groups for processing signals generated by the ranging pixels of the pixel groups to provide a plurality of ranging time of flight signals; and
a plurality of digital processing units, each of the digital processing units selectively coupled to at least one of the processing units and generating a plurality of histogram information according to the ranging time of flight signals; wherein the pixel groups detect returned light of an object at the same time so that histogram information includes at least one characteristic of the returned light.

14. The detector module as claimed in claim 13, wherein the processing units perform correlation processing on the signals generated by the ranging pixels coupled to the processing units.

15. The detector module as claimed in claim 13, wherein each of the processing units includes a plurality of quench/recharge processing circuits, and the quench/recharge processing circuits are coupled to the ranging pixels, respectively.

16. The detector module as claimed in claim 13, wherein the at least one characteristic of the returned light is correlated with the area of the first detection region and the area of the second detection region.

17. The detector module as claimed in claim 13, wherein the digital processing units provides a parameter of strong returned light according to the at least one characteristic of the returned light obtained by the first pixel group of the pixel groups.

18. A ranging device comprising:
a light emitting module, emitting a detection light;
a detector module, receiving the returned detection light to generate a detection signal, the detector module including a detector array including:
a plurality of pixel groups, each of the pixel groups including a plurality of ranging pixels, a first pixel group of the pixel groups including a plurality of first ranging pixels, each of the first ranging pixels including a first detection region, a second pixel group of the pixel groups including a plurality of second ranging pixels, each of the second ranging pixels including a second detection region, wherein area of the first detection region and area of the second detection region are different from each other;
a processor, coupled to the detector module and including a plurality of processing units, the processing units generating a plurality of ranging time of flight signals according to the detection signal; and
a digital processor, coupled to the processor and including a plurality of digital processing units, the digital processing units generating a plurality of histogram information and performing statistical computing according to the ranging time of flight signals.
